(19) United States
(12) Patent Application Publication
(10) Pub. No.: US 2005/0002671 A1
(43) Pub. Date: Jan. 6, 2005

(54) Wavelength division multiplexed optical transmission systems, apparatuses, and methods

(75) Inventors: David F. Smith, Ellicott City, MD (US); Michael C. Antone, Ellicott City, MD (US)

Correspondence Address: CORVIS CORPORATION;INTELLECTUAL PROPERTY DEPARTMENT, 7015 ALBERT EINSTEIN DRIVE, COLUMBIA, MD, 210469400, US

(73) Assignee: Corvis Corporation

(21) Appl. No.: 10/863,346

(22) Filed: Jun. 9, 2004

Related U.S. Application Data
(63) Continuation of application No. 09/441,805, filed on Nov. 17, 1999, now abandoned.
(60) Provisional application No. 60/108,751, filed on Nov. 17, 1998.

(51) Int. Cl. H04J 14/02

(52) U.S. Cl. 398/83

(57) ABSTRACT

Systems, apparatuses, and methods are disclosed that provide for provisioning optical systems such that information is transmitted to a destination on a wavelength allocated to carry information to that destination and at a bit rate particular to the destination. The optical system provides for high bit rate transmission over short spans of the optical system, while provisioning lower bit rates for use over longer spans of the system. In addition, the optical system can be provisioned such that wavelengths that have lower optical fiber transmission loss are allocated for transmission of information over greater distances and/or at higher transmission rates.

### CROSS-REFERENCE TO RELATED APPLICATIONS

This application is a continuation in part of commonly assigned U.S. Provisional Patent Application Ser. No. 60/108,751 filed Nov. 17, 1998, which is incorporated herein by reference.

### STATEMENT REGARDING FEDERALLY SPONSORED RESEARCH OR DEVELOPMENT

Not Applicable

### BACKGROUND OF THE INVENTION

The present invention is directed generally to the transmission of information in an optical communication system, or network. More particularly, the invention relates to provisioning and allocation of optical wavelengths and transmission rates in optic transmission systems to provide increased capacity.

Fiber optic transmission systems currently in use in the communications industry generally provide for transmission of optical signals from an optical transmitter to an optical receiver via one or more optical amplifiers. The distance between the transmitters and the receivers depends upon the amount of signal degradation that occurs during transmission. In optical systems, the optical signals must be regenerated before signal degradation introduces an unacceptable number of uncorrectable errors into the optical signals. Optical signal regeneration generally requires that the optical signal be converted back to an electrical signal. Regeneration is performed by electrically processing the electrical signals, such as by retiming, reshaping, amplifying etc., which is followed by a retransmission of the electrical signal as an optical signal.

The transmitters and receivers are generally arranged in terminals to form a point to point optical link, in which the electronic data are optically transmitted using the transmitter to the optical receiver and converted back to electrical signals. Point to point optical links are interconnected either serially in a back to back configuration or via an electronic switch to form a multiple link optical system. Therefore, if it is desired to transmit information over distances greater than the point to point span length of a system, then a series of back to back, point to point links will be connected to span the distance.

The transmitters, receivers, and associated equipment are often one of the largest component expenses in the optical system and along with the required real estate and facilities comprise a substantial portion of the optical system startup and operating costs. Therefore, it is desirable to maximize the distance between the terminals. However, the maximum distance between the transmitters and receivers is limited, in part, by the data transmission rate. High bit transmission rates increase the degradation of the optical signals by various mechanisms; thereby requiring that the transmitter and receiver be more closely spaced than in lower bit rate systems.

The competing factors of increased capacity and increased number and cost of transmitter and receivers at higher bit rates are prime considerations in optical system design. Another factor is determining the spacing between the transmitter and receiver is the communications traffic patterns. Transmitters and receivers will often be located at less than the maximum distance to accommodate communications traffic that is not being sent over the maximum distance of the system or the accommodate electrical switching at fiber intersection in the system. Also, add and drop devices are often used between the terminals to allow communications traffic to be added and/or dropped at locations spaced at distances less than the terminal spacing.

Until recently, the continued development of higher bit rate electronic equipment had been able to outpace the demand for transmission capacity. The higher bit rate equipment continued to facilitate the transmission of information using time division multiplexing (“TDM”) or direct streaming of the information onto a single wavelength optical signal.

The emergence of the Internet and other data communication systems has greatly increased the demand for capacity in fiber optic transmission systems. This demand quickly exhausted the available capacity of single wavelength data stream and TDM systems. In response to the increased demand for capacity, optical systems were developed that employ wavelength division multiplexing (“WDM”) to provide for multiple wavelength transmission of information at the transmission rate of the electronic equipment. The tradeoff between terminal spacing and higher bit rate equipment becomes especially important in WDM systems that span long distances that require large numbers of back to back terminals including receivers and transmitters for most, if not, every signal wavelength.

The interrelation of bit rate and terminal spacing in optical transmission links introduces difficulty in upgrading systems designed for lower bit rate equipment to higher bit rate equipment. The shorter transmission distance of higher bit rate electronic equipment is often not fully compatible, if at all, with existing optical links. Thus, optical links generally operate at a single bit rate and the terminal spacing is designed to operate at that bit rate.

In addition, new point to point optical links added to the optical system will generally be designed to use the highest bit rate available at the time of installation. As such, the various point to point links in a optical system may be operating at different bit rates.

The traditional approach to overcome bit rate differences between point to point links is to either demultiplex a higher bit rate signal or multiplex lower bit rate signals following the receiver to the bit rate of the next transmitter. Bit rate conversion can be performed using a number of methods, such as by manipulating the SONET or SDH frames, or by other methods known to one skilled in the art.

While bit rate conversion allows different bit rate point to point links to cooperate in a single optical network, the capacity of the networks is limited by the older links that generally have lower capacity. Given the increased demand for capacity of existing links, it would be desirable to increase the capacity of the links without requiring the replacement of existing optical links.

### BRIEF SUMMARY OF THE INVENTION

The present invention addresses the need for higher capacity optical transmission systems, apparatuses, and methods. Optical systems of the present invention are provisioned such that information is transmitted to a destination on a wavelength allocated to carry information to that destination and at a bit rate particular to the destination. The optical system provides for high bit rate transmission over short spans of the optical system, while provisioning lower bit rates for use over longer spans of the system. In addition, the optical system can be provisioned such that wavelengths that have lower optical fiber transmission loss are allocated for transmission of information over greater distances and/or at higher transmission rates.

In various embodiments, the system can include electrical multiplexers and demultiplexers that interface with the transmitters and receivers. In this manner, the system can be used to aggregate low bit rate traffic or inverse multiplex higher bit rate signal to bit rates more appropriate for the traffic volume and distance between the information origin and destination. The system may also include dedicated communication traffic signal channels, as well as mixed data and dedicated system information channels to be added and dropped at each or various optical components in the system.

In various embodiments, the system can be configured to include continuous optical paths that accommodate the ingress and egress of signal wavelengths at various bit rates without terminating the optical path. The system can be configured by allocating signal wavelengths to switching/routing hubs to allow to provide access paths for regeneration, aggregation, and system maintenance.

Optical systems of the present invention address the need for higher capacity optical systems using existing fiber plants, as well as for new fibers by providing, for example, simultaneous transmission of multiple bit rates within the system. Therefore, the optical system capacity can be tailored to efficiently use the bandwidth resources of the optical system and provide for higher capacity optical systems. These advantages and others will become apparent from the following detailed description.

### BRIEF DESCRIPTION OF THE DRAWINGS

Embodiments of the present invention will now be described, by way of example only, with reference to the accompanying drawings for the purpose of illustrating embodiments only and not for purposes of limiting the same; wherein like members bear like reference numerals and:

FIGS. 1-4 show optical system embodiments.

It will be appreciated that lines connecting elements in the drawings depict optical connectivity of the elements and not necessarily the absolute number of optical fibers connected between the elements, unless expressly stated.

### DESCRIPTION OF THE INVENTION

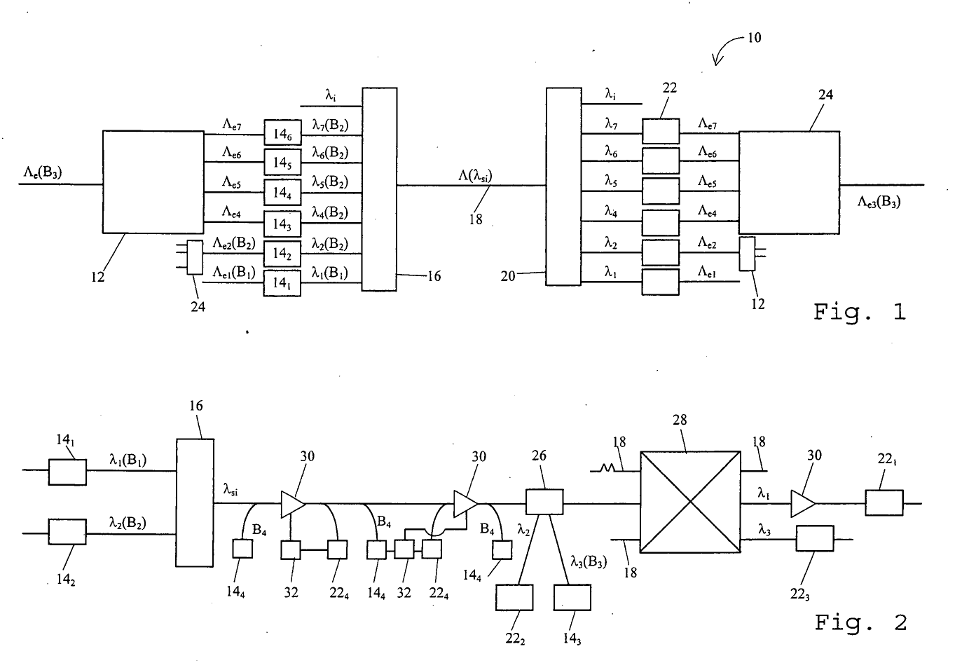

FIG. 1 shows an optical system 10 of the present invention embodied in a point to point transmission link. Electrical data signals Λₑ₁, Λₑ₂, and Λₑ₃ carrying information are provided to the system 10 at bit transmission rates B₁, B₂, and B₃, respectively, which could be, for example, various combinations of bit rates from STS-1 through STS-192 or greater.

An electrical demultiplexer 12 can be provided to demultiplex the electrical data signal Λₑ₃ (B₃) into a plurality of lower bit rate signals, for example, Λₑ₄₋₇ (B₂), that can be transmitted over the length of the system 10 without having to regenerate the electrical signals. The electrical signals Λ_{e1,2,4-7} are provided to one or more optical transmitters 14ₘ configured to transmit information via one or more information carrying signal wavelengths, or signal channels, λₛᵢ to one or more optical receivers 22ⱼ. An optical combiner 16 can be used to combine multiple signal wavelengths λₛᵢ into a WDM signal Λₒ for transmission through an optical transmission medium, such as optical fiber 18.

An optical distributor 20 can be provided to distribute the signal wavelengths λₛᵢ in the WDM optical signal Λₒ to a plurality of optical receiver 22 configured to receive and convert the information carried by the optical signal wavelengths λₛᵢ into electrical data signal Λ_{e1,2,4-7}. An electrical multiplexer 24 can be provided to multiplex lower bit rate electrical signals Λₑ₄₋₇ into a higher bit rate electrical signals Λₑ₃. Likewise, electrical multiplexers 24 and demultiplexers 12 can be provided proximate the transmitter and receivers, respectively, to aggregate and separate lower bit rate signals provided to the system 10.

The system 10 can also be embodied, as shown in FIG. 2, in network configurations including other optical components, such as one or more add/drop devices 26 and optical and electrical switches/routers/cross-connects 28 interconnecting the transmitters 14 and receivers 22. For example, broadcast and/or wavelength reusable, add/drop devices, and optical and electrical/digital cross connect switches and routers can be configured via a network management system in various topologies, i.e., rings, mesh, etc. to provide a desired network connectivity. The network management system can be used to communicate with and control the optical systems 10 via wide area networks external to the system 10 and/or transmitting system supervisory information via optical channels within the system 10. Optical amplifiers 30, such as doped, e.g., erbium, and Raman fiber amplifiers and semiconductor amplifiers, can be disposed along the fiber 18 to amplify signal wavelengths λₛᵢ attenuated by transmission through the fiber 18.

The transmitters 14ₘ can impart information to the signal wavelengths λₛᵢ by direct or external modulation of optical carrier sources or optical upconversion. The transmitters 14ₘ also can include various error correction and signal formatting and processing circuitry, such as forward error correction and SONET/SDH encoders, decoders, and termination devices. The receivers 22ⱼ can include both direct and coherent detection receivers. The receivers 22ⱼ can also include error correction and signal formatting and processing devices corresponding to those in the transmitters 14.

Generally speaking, M transmitters 14ₘ can be used to transmit I different signal wavelengths λₛᵢ to J different receivers 22ⱼ. In various embodiments, one or more of the transmitters 14 and/or receivers 22 can be wavelength tunable to provide wavelength allocation flexibility in the optical system 10. In addition, the system 10 can also be configured to carry uni- and bi-directional traffic on a single fiber 18.

The optical combiners 16 and distributors 20 can include wavelength selective and non-selective (“passive”) fiber and free space devices, as well as polarization sensitive devices. Passive or WDM couplers/splitters, circulators, dichroic devices, prisms, gratings, etc. can be used in combination with various tunable or fixed transmissive or reflective filters, such as Bragg gratings, Fabry-Perot devices, dichroic filters, etc. in various configurations of the optical combiners 16 and distributors 20. Furthermore, the combiners 16 and distributors 20 can include one or more stages incorporating various devices to multiplex, demultiplex, and broadcast signal wavelengths λₛᵢ in the optical systems 10.

In various embodiments, such as in FIG. 2, two optical transmitters 14₁ and 14₂ can be configured to transmit information on first and second optical wavelengths λ₁ and λ₂ at respective first and second bit transmission rates B₁ and B₂. The particular bit rate used for the first and second optical wavelengths λ₁ and λ₂ can be varied depending upon the distance over which it must be transmitted. In the FIG. 2 embodiments, the second optical wavelength λ₂ is dropped by the optical add/drop device 26, which also can add information carried by a third optical wavelength λ₃ at third bit transmission rate B₃. Because the second wavelength λ₂ is being transmitted over a shorter distance than first wavelength λ₁, the second wavelength λ₂ can be transmitted at higher bit rate to provide additional capacity between transmitter 14₂ and receiver 22₂. Similarly, the information carried by optical wavelength λ₃, from transmitter 14₃ to receiver 22₃ can be transmitted at yet a different bit rate. Again, it may be desirable to limit the third bit rate B₃ to the maximum bit transmission rate that can be used without having to regenerate the electrical signal.

In this manner, information being transmitted to different destinations can be sent at bit transmission rates appropriate to traffic capacity and distance between a particular origin to destination. For example, higher bit rate can be used over routes that do not span the entire distance of the lower bit rate systems. Likewise, lower bit transmission rates may be used in a system designed for higher transmission rates, if the traffic capacity does not economically justify the use of higher bit rate transmitters and receivers or the use of lower bit rates could eliminate regeneration sites between the origin and destination. Depending upon the traffic volume, it is desirable to select a bit rate that may require electrical regeneration prior to the destination, but will more efficiently use available system resources.

It is often the case that information is provided to the system at a higher bit rate than can not be transmitted through the system 10 without regeneration. In those instances, it may be necessary to regenerate the signal during transmission between the origin and destination.

Alternatively, as shown in FIG. 1, the information can be inverse multiplexed into two or more lower bit rate streams that can be transmitted to the destination without regeneration or with fewer regeneration sites. Inverse multiplexing, when applied to SONET signals constructed from lower bit rate SONET signals can be merely a demultiplexing of the high bit rate SONET signal into its low bit rate SONET components. The information being transmitted can be recovered from the lower bit rate signals without inverse demultiplexing the lower bit rate signals into the higher bit rate signal. Whereas, inverse multiplexing of concatenated SONET signals fragments the information, requiring the IM signals be inversed demultiplexed to recover the information. While inverse multiplexing is known in the art, there are difficulties with the schemes, particularly in concatenated data streams.

A primary difficulty with inverse multiplexing is that the inverse multiplexed data streams will travel from the origin through the optical systems at different rates causing a misalignment, or skew, of the data at the destination. In parallel optical systems, transmission path lengths for the inverse multiplexed signals are equalized as much as possible to lessen the skew between the signals. In WDM systems, while a common fiber is used, chromatic dispersion of the different wavelengths carrying the inverse multiplexed signals, as well as the mux/demux structure of the WDM system can greatly increase the skew.

Various methods can be applied to compensate for the skewing of inverse multiplexed signals. For example, U.S. Pat. No. 5,461,622 suggests using both framing and pointer bytes in SONET overhead to deskew the information. Unfortunately, the amount of skew introduced by the system 10 can vary with the system conditions, which can degrade the system performance, particularly in WDM systems. For example, variations in the wavelengths one or more of the transmitters used to transmit the inverse multiplexed signals can caused variations in the amount of skew in the system 10.

In one aspect of the present invention, the transmitters 14 are configured to upconvert two or more inverse multiplexed signals onto different subcarriers of a single optical carrier wavelength provide by a transmitter. The frequency spacing between subcarrier can be substantially less than between adjacent carriers, so as to greatly decrease the dispersion and resultant skew between the inverse multiplexed signals during transmission in WDM systems. In addition, transmitting the inverse multiplexed signals on subcarriers of a common optical carrier essentially eliminates path length differences introduced by WDM multiplexing schemes.

Various subcarrier modulation techniques can be employed to upconvert the inverse multiplexed data streams onto the subcarriers. Single sideband, suppressed carrier upconversion techniques can be used to minimize unwanted mirror image subcarrier and carrier wavelengths being transmitted along with the signal wavelengths λₛᵢ. Although conventional double sideband, non-suppressed carrier, subcarrier modulation techniques also can be employed. An example of single sideband, suppressed carrier transmitters suitable for use in the present invention are described in commonly assigned copending U.S. application Ser. No. 09/185,820 filed Nov. 4, 1998, the disclosure of which is incorporated herein by reference.

The number of inverse multiplexed signals may or may not coincide with the number of subcarriers being upconverted on a single transmitter. When the number of inverse multiplexed signals does not correspond to the number of subcarriers, the inverse multiplexed signals can be upconverted onto two or more transmitters transmitting information that provide adjacent signal wavelengths in a wavelength channel plan. For example, placing two subcarriers on each of two adjacent carriers can decrease the dispersion and resultant skew between the inverse multiplexed signals by a factor of 2-3 times compared to the skew using four carriers.

Inverse multiplexing can be used to separate and transmit concatenated and unconcatentated higher bit rate information streams, e.g., OC-768c & OC-768, OC-192c & OC-192, etc. The inverse multiplexed signals can be framed with appropriate transmission overhead at lower bit rates to allow the inverse multiplexed signals to be deskewed and recombined into the higher bit rate signal at the end of the link. The deskewing can be performed using the framing A1 and A2 bytes in the transmission overhead or additional bytes, as previously discussed.

In various embodiments, the receivers are configured to coherently detect two or more of the subcarriers carrying the inverse multiplexed signals. Coherent detection of the subcarriers eliminates much of the path variability introduced by demultiplexing and direct detection of the inverse multiplexed signals. Coherent detection can be performed using a remnant of the carrier wavelength with or without a local oscillator providing a heterodyne signal. In various embodiments, the local oscillator can be locked using the remnant carrier wavelength to ensure proper tracking of any drift in the carriers and subcarriers during operation. In fact, a tunable local oscillator can provide additional flexibility in configuring receivers 22 in the system 10.

As further shown in FIG. 2, a fourth optical wavelength λ₄ at a fourth bit rate B₄ can be used to provide system supervisory/service information between the optical components in the system 10. Generally, the various optical components, such as optical amplifiers 30, add/drop devices 26, switches 28, receivers 22, and transmitters 14, etc. are provided in nodes and node to node communication is provided via the fourth optical wavelength λ₄. Optical component controllers 32 are provided to process the system information carried on the fourth wavelength λ₄ and control the optical components with the node in accordance with the system information. The optical component controllers 32 also provide component status reports that are transmitted using the fourth wavelength transmitters 14₄.

Generally, the distance between successive optical components is not great (e.g., 40-100 km), thereby allowing the use of high bit rates for transmission in the fourth optical wavelength λ₄, as previously discussed. However, the cost of providing transmitter/receiver pairs at each optical component is generally a prime consideration in determining the maximum bit rate to transmit system information. As such, the amount of system information that must be transmitted between optical components is generally used to set the minimum bit rate and associated costs for transmitter/receiver pairs.

It may be appropriate, in some instances, to place only the system information on the fourth optical wavelength λ₄ to provide a dedicated supervisory/service channel. However, the amount of system information generally does not warrant the expense of a dedicated supervisory/service channel.

In the present invention, the fourth bit rate B₄ is selected to have sufficient capacity to carry communications traffic, in addition to providing capacity for system information. For example, relatively inexpensive transmitters and receivers can be employed at fourth bit rates B₄ comparable to ITU standard OC-1 bit rates, that provide sufficient capacity to carry communications traffic and the system information can be interleaved, as necessary. As previously stated, substantially higher bit rates can be used for the fourth bit rate B₄, and may be appropriate when the demand for capacity justifies the additional cost associated with higher bit rate transmitters and receivers.

When communications traffic and system information is interleaved, the system information has to be electrically demultiplexed at each optical component to separate the system information intended for that optical component. The communications traffic carried on the fourth optical wavelength λ₄ is then electrically multiplexed with the new system information and passed from component to component until it reaches its destination.

In the present invention, the fourth optical wavelength λ₄ also can be configured to carry other non-system information, such as service provider order wires. In these embodiments, the communications traffic, order wire traffic, and system supervisory information can be multiplexed together to provide a multiple protocol, mixed data channel.

The use of a mixed data channel gives a service provider increased access to the communications traffic at each component. Thus, a service provider can further configure the optical component controllers 32 to allow communication traffic to be added and dropped from the mixed data channel at the optical components. In this manner, direct access to the system 10 can be provided at optical component locations that would not otherwise have direct access to the system 10. For example, the mixed data channel can be used to aggregate traffic that can be further aggregated and/or reassigned to dedicated communication traffic channels at subsequent nodes in the system 10. In addition, the system 10 can be designed to include one or more dedicated communications traffic channels that are added and dropped at each optical component with the mixed data channel or at selected optical components. The component add/drop communications traffic channels provide further access to the system 10, which could be used to access other systems, such as local transmission rings.

In another aspect of the system 10, the optical wavelengths can be provisioned based on the distance between the origin and the destination and the optical loss, or attenuation, associated with transmitted a particular wavelength through the transmission fiber 18. For example, information being transmitted over longer distances in SMF-28 type fiber can be carried using wavelengths having lower loss/distance, such as between 1520-1580 nm. Whereas, information being carried over shorter distances can be transmitted in wavelengths having higher loss/distance. Continuing the example, wavelengths typically having higher loss per distance in SMF-28, such as wavelengths longer than 1580 nm or shorter than 1520 nm including the 1300 nm transmission window can be used to carry traffic over shorter distances.

Similarly, wavelengths that have very low or very high dispersion can be used to transmit signals over short distances. In the case of very low dispersion fibers (e.g., <1 ps/nm/km), the input signal power can be lowered to decrease non-linear interactions and; therefore, are more suitable for short transmission distances. Whereas, very high dispersion wavelengths also may be more suitable for transmitting information over shorter distances to minimize the effects of cumulative dispersion on the signal quality, in the absence of effective dispersion compensation.

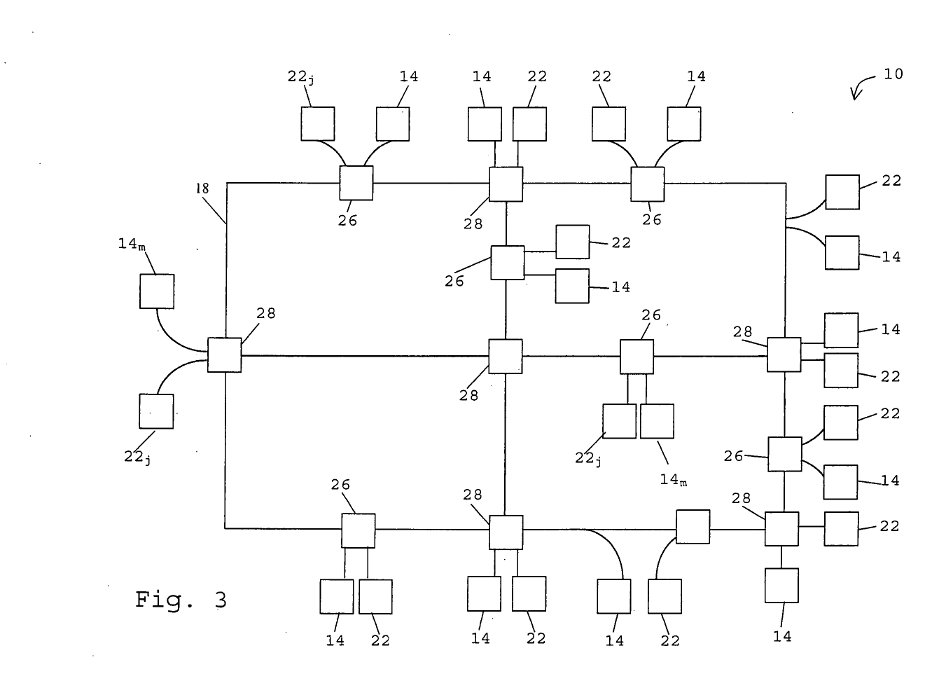

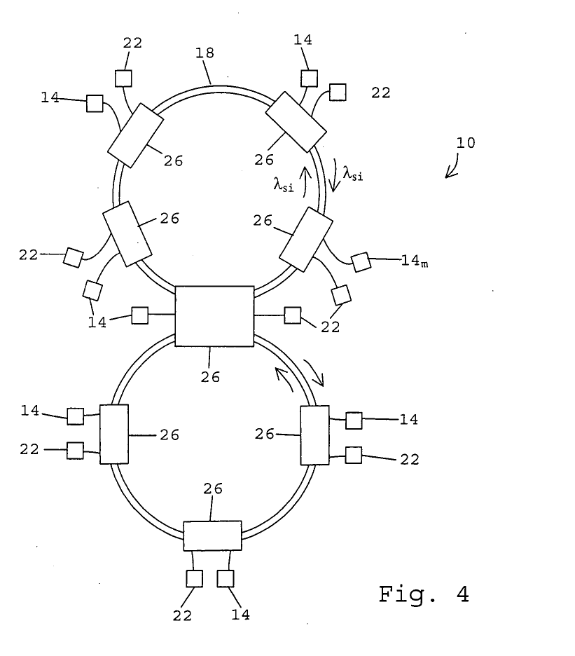

The system 10 of the present invention can be embodied as a network in both mesh and ring configurations, such as shown in FIGS. 3 and 4, as well as other configurations One skilled in the art will appreciate that when a plurality of rings are interconnected via optical switches, the interconnected rings can be configured to provide for mesh-like protection paths involving more than one ring. The interconnection of the rings provides alternate path options in addition to, or in lieu of, the clockwise/counterclockwise paths in isolated rings.

In the present invention, the system 10 can be configured in mesh cells, interconnected rings, or otherwise to eliminate, minimize, and/or optimize the amount of optical signal regeneration performed between the origin and destination nodes. Optical signals are introduced into the system 10 via either optical add/drop multiplexers 26 or optical switches 28 depending upon the number of communication paths and the amount of communications traffic that is being added and/or dropped at a point of presence. Selective optical to electrical conversion and optical signal regeneration can be performed, if necessary, at either the optical switches 28 and/or the optical add/drop device 26 to transmit optical signals to their respective destinations. If multiple fibers are used, primary and protection paths can be provisioned by configuring the optical switch 28 accordingly.

Unlike prior point to point systems, the system 10 does not require that all optical wavelengths λᵢ be terminated, electrically regenerated, reconverted to optical wavelengths, and transmitted at any point in the system. In this manner, optical to electrical to optical (“OEO”) conversions can be minimized or eliminated between the origin and destination nodes in the system 10. Thus, the number of transmitters 14ᵢ and receivers 22ᵢ required in the system can be greatly reduced. In some configurations, it may be appropriate to occasionally terminate the optical path and regenerate optical signals for information continuing through the network to better provide for wavelength management and/or to eliminate amplified spontaneous emission (“ASE”) noise from the system. While the present invention has been described primarily with respect to electrical regeneration of optical signals, the invention is generally applicable to optical regeneration techniques that have been proposed or will be developed.

Configurations of the system 10, such as those in FIGS. 3 and 4, can be used to provide continuous optical paths forming a transparent all-optical network. The establishment of a continuous optical path provides flexibility in the optical wavelengths and bit transmission rates used in system 10 in that no OEO regeneration occurs in the continuous optical path. Ingress to and egress from the continuous optical path is optically provided via optical add/drop multiplexers and optical switches. OEO regeneration that is required prior to reaching the information destination is performed external to the continuous optical path. ASE noise that may accumulate in the continuous optical path can be selectively removed, when optical signals are being added and/or dropped and/or by filtering or blocking at the optical switch or independently of any other optical component.

The optical switch 28 can be configured to provide transparent routing of optical signals from one or more input ports to one or more output ports. An example of optical switches 28 suitable for use in the present invention are reconfigurable routers described in commonly assigned U.S. patent application Ser. No. 09/119,562 (the “'562 switch”), which is incorporated herein by reference. In the '562 switch configurations, information is routed to the information destinations in wavebands, each of which can include one or more optical wavelengths carrying information between the information origin and the information destination. The optical switch serves as a reconfigurable router that can be operated statically during normal operation, but can be reconfigured to implement protection strategies and/or changes in communications traffic patterns. Thus, large numbers of optical wavelengths, i.e., information channels, can be optically routed and rerouted without performing OEO conversion in the continuous optical path.

The interconnection of numerous optical links in the present invention provides flexibility in the assignment of wavelengths and optical paths for transmitting information between information origins and destinations. The increased flexibility and versatility of the system 10 also means that additional consideration must be given to issues such as wavelength contention and the formation of optical rings.

In an embodiment of the present invention, wavebands, i.e., groups of wavelengths, are allocated in a network by assigning wavebands to optical switches and OADMs that serve as optical hubs. The wavelengths in wavebands assigned to a particular hub must exit a continuous path in the network at the assigned hub. The use of the optical hub prevents the system configurations that might result in the formation of an optical loop in the network. The optical hub strategy also accommodates network protection via the unique allocation of protection paths through the system 10.

An example of the optical hub allocation strategy is provided with respect to a four optical switch mesh block or ring providing a continuous path shown as “A” in FIG. 4, and assuming two fibers, optical paths 1 and 2, are used to provide connectivity between the optical switches 28₁₋₄. Optical switch 28₁ can be used to route information to and from optical switches 28₂₋₄ in block A, and also to the switches and OADMs in the block B. One or more wavebands can be assigned to optical switch 28₁, and designated as waveband Λ₁.

The optical switch 28₁ will then serve as an optical hub for waveband Λ₁ meaning that all information carried by wavelengths within waveband Λ₁ will exit block A via the first optical switch 28₁. The non-hub optical switches 28₂₋₄ in the block A will be configured to pass all wavelengths in the first waveband Λ₁ through the switch on the same optical path on which the wavelength entered the switch. This is, if a wavelength entered the switch via the first optical path 1, the wavelength will exit the switch on the first optical path 1. In addition, the non-hub optical switches 28₂₋₄ can be configured to broadcast the first waveband Λ₁ to any receivers or other paths associated with non-hub switch. Thus, the first waveband Λ₁ will travel around the same optical path until it encounters the first optical switch 28₁ at which time the wavelength will be switched to a different optical path or removed from the system. The hub assignment can be used to effectively remove traffic from the continuous path to allow for regeneration, aggregation, and wavelength conversion of the signal wavelengths λₛᵢ, as well as system maintenance.

In this embodiment, the wavelengths within first waveband Λ₁ are uniquely assigned to one of the other nodes, i.e., optical switches or OADMs within the continuous optical path A. One or more wavelengths can be assigned to each node depending upon the communications traffic between the particular node and the waveband hub.

Likewise, the second optical switch 28₂ can serve as a hub for a second waveband Λ₂ and the individual wavelengths within the second waveband Λ₂ can be assigned to optical switches 28_{1,3,4}. A similar procedure can be followed for the other optical nodes in the block A.

Either the first or second optical paths, 1 and 2, in the continuous optical path A can be the primary path for transmission from the hub node to the non-hub nodes. The other optical path will serve as the protection path. For example, the first optical path 1 can serve as the primary path for information originating from the first optical switch 28₁ and the protection path for information originating from the other nodes. Whereas, the second optical path 2 can serve as the primary path for information originating from the other nodes and the protection path for information originating from the first optical switch 28₁.

Protection using the waveband hubs can be provided in a one for one (“1:1”) manner in which the signal is switched from the primary path to the protection path upon the loss of signal in the primary path. Continuing the example from the preceding paragraph, if a fiber cut occurs between the first and second optical switches, 28₁ and 28₂, optical signals in the first waveband Λ₁ originating from the first optical switch 28₁ will be switched to the second fiber path 2. Likewise, optical signals originating from the other optical switches 28₂₋₄ will be switched to the first optical path 1.

Other waveband allocation schemes, such as assigning unique wavebands to pairs of nodes or common wavebands to adjacent nodes, and protection schemes can be provided in the present invention. For example, one plus one (“1+1”) protection can also be performed using optical waveband switches by uniquely assigning wavebands to carry information between two nodes. For example, all information being transmitted between the first and second optical switches 28₁ and 28₂ would be carried by wavelengths with the first waveband Λ₁. The first and second optical switches 28₁ and 28₂ would be configured to remove any wavelengths in the first waveband Λ₁ that enter the switches on the first and second optical paths, 1 and 2. Conversely, the third and fourth optical switches 28₃ and 28₄ route any wavelengths entering the switches onto the same optical path exiting the switches. In this manner, both first and second optical paths 1 and 2 can simultaneously be used as primary and protection transmission paths.

The protection signal in the 1+1 protection scheme can be eliminated by appropriate provisioning of the switch, or the use of line switches. Alternatively, both the primary path signal and the secondary path signal can be received and one of the two signal can be selected. The selection of the optical signal can be performed at the optical receiver level or in the electrical domain, for example in an IP router.

A 1+1 protection scheme can also be provided, if individual wavelength blockers, such as individual wavelength OADMs and switches and/or filters, are provided in the system 10. Thus, the individual wavelengths are removed from or exit the continuous path A at both assigned nodes. The other nodes in the continuous path A would be configured to allow the non-assigned wavelengths to exit the node on the same optical path that it entered the node. It should be noted that the use of individual wavelength switches can greatly increase the complexity of the system as the number of wavelengths used in the system is increased.

Those of ordinary skill in the art will appreciate that numerous modifications and variations that can be made to specific aspects of the present invention without departing from the scope of the present invention.

1-14. (cancelled)

15. An optical communication system comprising:
at least three optical nodes interconnected by at least one optical transmission fiber to create a continuous optical path for a plurality of optical signal channels to pass between and through the nodes, each node including
at least one of an OADM and an optical switch configured to provide at least one continuous optical path through the node and to provide optical signal ingress and egress to the continuous optical path to allow optical signals to be added and dropped from the continuous optical path without terminating the optical path,
at least two of the nodes including at least one of an optical transmitter to transmit signal for ingress and an optical receiver optical signal that egress from the continuous optical path, respectively, and wherein at least one of the optical signal channels optically passes through the nodes and at least one of the optical signal channels are selectively regenerated by the transmitters and receivers.

16. The system of claim 15, wherein the optical transmitter and receiver are one of a plurality of optical transmitters and receivers.

17. The system of claim 15, wherein the optical transmitter optically communicate with a plurality of optical receivers via the continuous optical path.

18. The system of claim 15, wherein the system include other optical nodes in addition to the at least three optical nodes.

19. The system of claim 15, wherein each optical node includes a plurality of optical transmitters and optical receivers configured to provide optical signal for ingress and egress from the continuous optical path.

20. The system of claim 15, wherein each optical node is designated as an optical hub for at least one waveband including at least one signal channel, wherein the waveband exits the system at the designated node and is not optically passed through the node.

21. The system of claim 20, wherein each waveband in the system is assigned to at least one hub.

22. The system of claim 21, wherein each waveband includes one optical wavelength carrying information.

23. The system of claim 22, wherein each optical wavelength optically pass through non-hub optical nodes.

24. The system of claim 20, wherein at least one non-hub optical nodes is configured to broadcast at least one waveband.

25. The system of claim 15, wherein at least one node is configured to block ASE in a particular wavelength from passing through the optical node in the continuous optical path.

26. The system of claim 25, wherein the at least three optical nodes are configured to block ASE in the continuous optical path.

27. The system of claim 15, wherein the system includes at least one mixed data channel configured to carry system information and communications traffic that is added and dropped at each of the nodes and optical amplifiers, wherein system information within the mixed data channel is processed by an optical component controller within the optical nodes and optical amplifier and at least one signal wavelength that optically passes through the optical amplifiers and at least one node between two other optical nodes.

28. An optical communication system comprising:
at least three optical nodes interconnected by at least one optical transmission fiber to create a continuous optical path for a plurality of optical signal channels to pass between and through the nodes, each node including at least one of an OADM and an optical switch configured to provide at least one continuous optical path through the node and to provide optical signal ingress and egress to the continuous optical path to allow optical signals to be added and dropped from the continuous optical path without terminating the optical path, and,
at least one optical amplifier disposed between each of the optical nodes providing ingress and egress to the continuous optical path; wherein
at least one mixed data channel configured to carry system information and communications traffic that is added and dropped at each of the nodes and optical amplifiers, wherein system information within the mixed data channel is processed by an optical component controller within the optical nodes and optical amplifier and at least one signal wavelength that optically passes through the optical amplifiers and at least one node between two other optical nodes.

29. The system of claim 28, wherein the optical component controllers are configured to provide component status report via the mixed data channel.

30. The system of claim 28, wherein the optical component controllers are configured to provide component status report via the mixed data channel.

31. The system of claim 28, wherein the mixed data channel is at bit rate that is different than a first signal wavelength, which is different than the bit rate of a second signal wavelength.

32. The system of claim 31, wherein the bit rate of the first signal wavelength is different than the bit rate of a second signal wavelength.

33. The system of claim 28, wherein at least one optical signal wavelength is broadcast via an optical switch in one nodes to at least two other optical nodes.

34. The system of claim 33, wherein the at least two other optical nodes arc less than the total number of other nodes in the system.
